(19) United States
(12) Patent Application Publication
(10) Pub. No.: US 2011/0261048 A1
(43) Pub. Date: Oct. 27, 2011

(54) ELECTRONIC DEVICE AND METHOD FOR DISPLAYING THREE DIMENSIONAL IMAGE

(75) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 12/876,252

(22) Filed: Sep. 7, 2010

(30) Foreign Application Priority Data
Apr. 26, 2010 (TW) 99113010

(51) Int. Cl. G06F 3/041; G06T 15/00

(52) U.S. Cl. 345/419; 345/173

(57) ABSTRACT

A system and method for displaying a three dimensional (3D) image on a touch screen of an electronic device detects an initial touch point and an end touch point of a touch motion, when the touch screen is touched. Then the method creates a coordinate system for the touch screen, and calculates a motion direction and a motion angle of the touch motion according to coordinates of the initial touch point and the end touch point in the coordinate system. Additionally, the method adjusts a display orientation of the 3D image displayed on the touch screen according to the motion direction and the motion angle, and displays the adjusted 3D image on the touch screen.

### BACKGROUND

1. Technical Field

Embodiments of the present disclosure relate to image display technology, and particularly to an electronic device and a method for displaying a three dimensional (3D) image.

2. Description of Related Art

Currently, 3D images of an object can be displayed on a display screen of an electronic device. However, the user cannot change the display orientation of the 3D images on the display screen. Therefore, an improved and efficient method for displaying the 3D images is desired.

### BRIEF DESCRIPTION OF THE DRAWINGS

FIG. 1 is a block diagram of one embodiment of an electronic device.

FIG. 2 is a flowchart of one embodiment of a method for displaying a 3D image using the electronic device of FIG. 1.

FIG. 3 is a schematic diagram of a coordinate system of a touch screen of the electronic device.

FIG. 4 is a schematic diagram of one embodiment for adjusting a display orientation of a 3D image by rotating the 3D image.

FIG. 5 is a schematic diagram of one embodiment for adjusting the display orientation the 3D image by a searching method.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

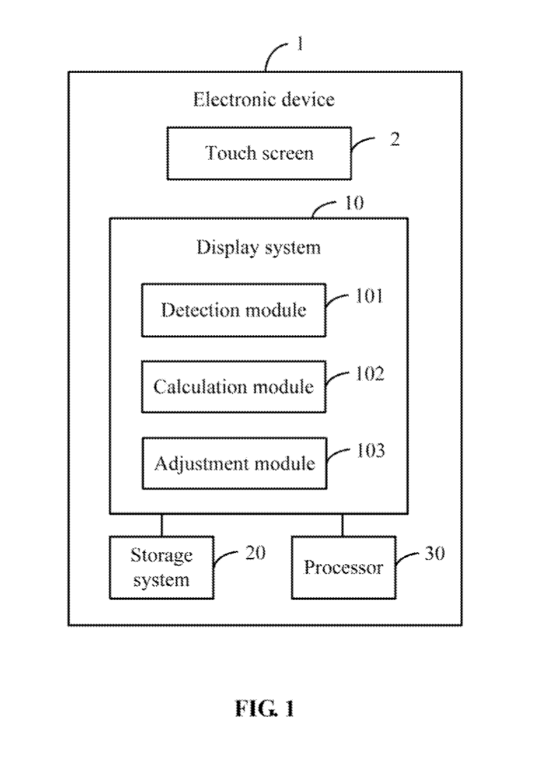

FIG. 1 is a block diagram of one embodiment of an electronic device 1. In the embodiment, the electronic device 1 includes a touch screen 2, a display system 10, a storage system 20 and a processor 30. In some embodiments, the electronic device 1 may be an electronic book, a mobile phone, a personal digital assistant (PDA), mobile internet device (MID), or any other electronic devices that can display three dimensional (3D) images. It should be apparent that FIG. 1 is only one example embodiment of the electronic device 1 and it can included more or fewer components than shown in other embodiments, or a different configuration of the various components.

The storage system 20 stores one or more programs, such as programs of an operating system, and other applications of the electronic device 1. In some embodiments, the storage system 20 may be random access memory (RAM) for temporary storage of information, and/or a read only memory (ROM) for permanent storage of information. In other embodiments, the storage system 20 may also be an external storage device, such as a hard disk, a storage card, or a data storage medium. The processor 30 executes one or more computerized operations of the electronic device 1 and other applications, to provide functions of the electronic device 1.

The display system 10 may include a number of functional modules including one or more computerized instructions that are stored in the storage system 20 or a computer-readable medium of the electronic device 1, and executed by the processor 30 to perform operations of the electronic device 1. In the embodiment, the display system 10 includes a detection module 101, a calculation module 102, and an adjustment module 103. In general, the word “module”, as used herein, refers to logic embodied in hardware or firmware, or to a collection of software instructions, written in a programming language, such as, Java, C, or Assembly. One or more software instructions in the modules may be embedded in firmware, such as EPROM. The modules described herein may be implemented as either software and/or hardware modules and may be stored in any type of computer-readable medium or other storage device.

The detection module 101 is operable to detect an initial touch point and an end touch point of a touch motion when the touch screen 2 is touched by a user. In one embodiment, the user may slide a stylus or a finger across the touch screen 2.

The calculation module 102 creates a coordinate system for the touch screen 2, and calculates a motion direction and a motion angle of the touch motion according to coordinates of the initial touch point and the end touch point in the coordinate system. Details of calculating the motion direction and the motion angle are described as follows.

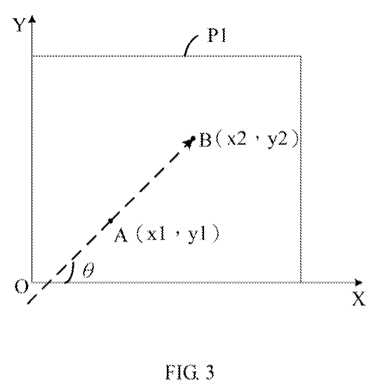

FIG. 3 is a schematic diagram of the coordinate system of the touch screen 2. Assuming that a coordinate system XOY in FIG. 3 is the coordinate system of the touch screen 2, and the rectangle P1 is the touch screen 2. The origin of the coordinate system is a vertex O of the touch screen 2, X axis is along with a horizontal edge of the touch screen 2, and Y axis is along with a vertical edge of the touch screen 2. The motion direction is determined by the coordinates of the initial touch point and the end touch point. The motion angle is formed by the motion direction and the X axis (e.g., angle θ in FIG. 3). In one embodiment, the initial touch point is point A in FIG. 3, and the end touch point is point B in FIG. 3. The coordinate of point A is (x1, y1), and the coordinate of point B is (x2, y2). If x2 is greater than x1, and y2 is greater than y1, the motion direction is up to the right on the touch screen 2, and the motion angle θ=argtan[(y2−y1)/(x2−x1)], which is greater than 0 degrees and less than 90 degrees. If x2 is equal to x1, and y2 is greater than y1, the motion direction is vertically straight up on the touch screen 2. In the embodiment, the motion direction may be, up, down, left, right, up to the left, up to the right, down to the left, or down to the right for example.

The adjustment module 103 adjusts a display orientation of a 3D image displayed on the touch screen 2 according to the motion direction and the motion angle, and displays the adjusted 3D image on the touch screen 2. Details of adjusting the display orientation of the 3D image are provided below.

In response to the motion direction and the motion angle, the adjustment module 103 rotates the 3D image in a predetermined rotation mode to change the display orientation of the 3D image. The predetermined rotation mode corresponds to the motion direction and the motion angle. For example, if the motion direction is right on the touch screen 2 and the corresponding motion angle is 0 degrees. The predetermined rotation mode in response to the motion direction (right) and the motion angle (0 degrees) is to rotate the 3D image from a right direction to a left direction 90 degrees around a geometrical center of the 3D image. If the motion direction is up to the right on the touch screen 2 and the corresponding motion angle is between 0 degrees and 90 degrees. The predetermined rotation mode in response to the motion direction (up to the right) and the motion angle (0 degrees to 90 degrees) is to rotate the 3D image from the left direction to the right direction 45 degrees around the geometrical center. Then rotate the 3D image from an up direction to a down direction 45 degrees around the geometrical center. As mentioned above, different motion directions and motion angles correspond to different rotation modes.

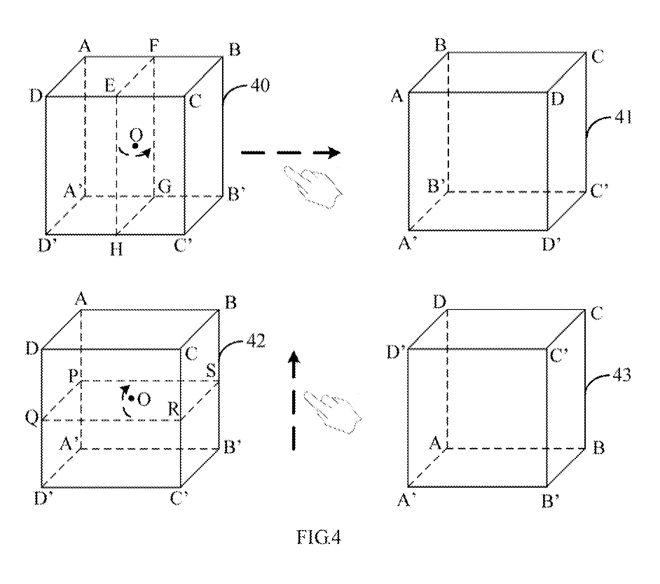

FIG. 4 is a schematic diagram of one embodiment for adjusting the display orientation of the 3D image by rotating the 3D image. Assuming that the 3D image displayed on the touch screen 2 is a cube 40 (represented by ABCD-A′B′C′D′ in FIG. 4). When a finger or a stylus slides across the touch screen 2, the calculation module 102 determines that the motion direction is to the right and the corresponding motion angle is 0 degrees. The adjustment module 103 rotates the cube 40 from the left direction to the right direction (e.g., a direction indicated by an arrowhead in the cube 40 of FIG. 4) 90 degrees around the center “O”. The rotated cube is a cube 41 shown in FIG. 4. When a finger or a stylus slides across the touch screen 2, the motion direction is up and the corresponding motion angle is 90 degrees. The adjustment module 103 rotates the cube 40 from the down direction to the up direction (e.g., a direction indicated by an arrowhead in a cube 42 of FIG. 4) 90 degrees around the center O. The rotated cube is the cube 43 shown in FIG. 4.

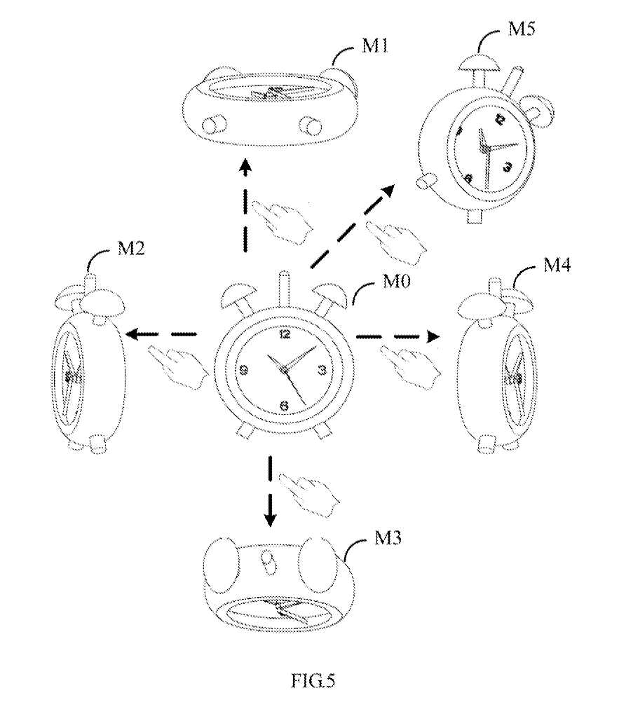

In another embodiment, the adjustment module 103 searches for a 3D image model stored in the storage system 20 according to the motion direction and the motion angle to adjust the display orientation of the 3D image, and displays the searched 3D image model as the adjusted 3D image on the touch screen 2. In the embodiment, a number of 3D image models may be pre-stored in the storage system 20. The number of 3D image models may be preset using a multimedia platform for creating animation and interactivity, such as Adobe Flash, or using a 3D software tool, such as the Google SketchUp or Maya. In one example with respect to FIG. 5, assuming that a 3D image of a clock (e.g., M0 in FIG. 5) is displayed on the touch screen 2. The 3D image modes M1, M2, M3, M4, and M5 are 3D image modes of the clock under different visual angles corresponding to different motion directions and motion angles. In some embodiments, if the motion direction is up and the corresponding motion angle is 90 degrees, the adjustment module 103 searches for the 3D image model M1 from the storage system 20, and displays the 3D image model M1 as the adjusted 3D image of the clock on the touch screen 2. If the motion direction is up to the right and the corresponding motion angle is between 0 degrees and 90 degrees, the adjustment module 103 searches for the 3D image model M5, and displays the 3D image model M5 as the adjusted 3D image of the clock on the touch screen 2.

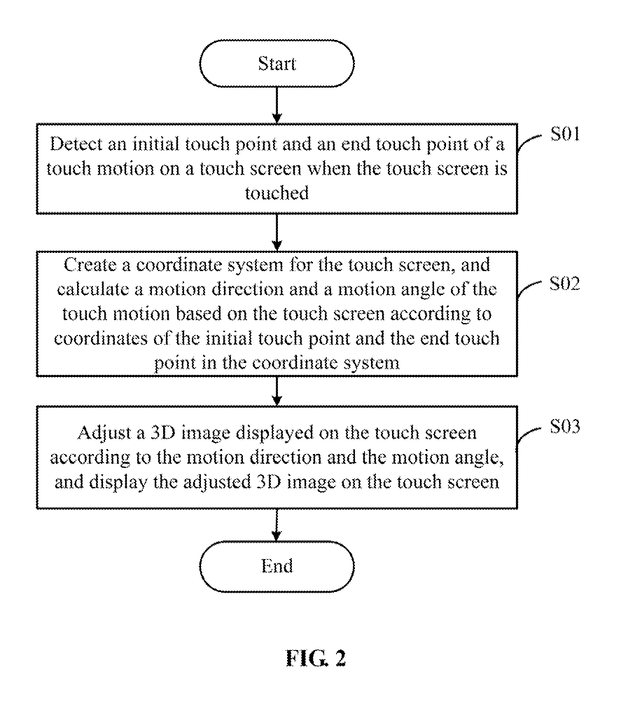

FIG. 2 is a flowchart of one embodiment of a method for displaying a 3D image using the electronic device 1 of FIG. 1. The method can adjust a display orientation of a 3D image displayed on the touch screen 2 according to touch operations of a user. Depending on the embodiment, additional blocks may be added, others removed, and the ordering of the blocks, may be changed.

In block S01, the detection module 101 detects an initial touch point and an end touch point of a touch motion when the touch screen 2 is touched by a user. In one embodiment, the user may slide a stylus or finger across the touch screen 2.

In block S02, the calculation module 102 creates a coordinate system for the touch screen 2, and calculates a motion direction and a motion angle of the touch motion according to coordinates of the initial touch point and the end touch point in the coordinate system. Details of calculating the motion direction and the motion angle are described above.

In block S03, the adjustment module 103 adjusts the display orientation of the 3D image displayed on the touch screen 2 according to the motion direction and the motion angle, and displays the adjusted 3D image on the touch screen 2. Details of adjusting the 3D image are described above.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. An electronic device comprising:
a touch screen operable to display a three dimensional (3D) image; and
a display system comprising:
a detection module operable to detect an initial touch point and an end touch point of a touch motion on the touch screen when the touch screen is touched;
a calculation module operable to create a coordinate system for the touch screen, and calculate a motion direction and a motion angle of the touch motion according to coordinates of the initial touch point and the end touch point in the coordinate system; and
an adjustment module operable to adjust a display orientation of the 3D image according to the motion direction and the motion angle, and display the adjusted 3D image on the touch screen.

2. The electronic device according to claim 1, wherein the adjustment module adjusts the display orientation of the 3D image by rotating the 3D image in a rotation mode corresponding to the motion direction and the motion angle.

3. The electronic device according to claim 1, wherein the adjustment module adjusts the display orientation of the 3D image by searching for a 3D image model stored in a storage system of the electronic device according to the motion direction and the motion angle.

4. The electronic device according to claim 1, wherein the touch screen is touched by a user using a stylus or a finger to slide across the touch screen.

5. A method for displaying a three dimensional (3D) image, the method comprising:
detecting an initial touch point and an end touch point of a touch motion on a touch screen of an electronic device when the touch screen is touched;
creating a coordinate system for the touch screen, and calculating a motion direction and a motion angle of the touch motion according to coordinates of the initial touch point and the end touch point in the coordinate system; and
adjusting a display orientation of the 3D image displayed on the touch screen according to the motion direction and the motion angle, and displaying the adjusted 3D image on the touch screen.

6. The method according to claim 5, wherein the display orientation of the 3D image is adjusted by rotating the 3D image in a rotation mode corresponding to the motion direction and the motion angle.

7. The method according to claim 5, wherein the display orientation of the 3D image is adjusted by searching for a 3D image model stored in a storage system of the electronic device according to the motion direction and the motion angle.

8. The method according to claim 5, wherein the touch screen is touched by a user using a stylus or a finger to slide across the touch screen.

9. A storage medium storing a set of instructions, the set of instructions capable of being executed by a processor of an electronic device to perform a method for displaying a three dimensional (3D) image, the method comprising:
detecting an initial touch point and an end touch point of a touch motion on a touch screen of the electronic device when the touch screen is touched;
creating a coordinate system for the touch screen, and calculating a motion direction and a motion angle of the touch motion according to coordinates of the initial touch point and the end touch point in the coordinate system; and
adjusting a display orientation of the 3D image displayed on the touch screen according to the motion direction and the motion angle, and displaying the adjusted 3D image on the touch screen.

10. The storage medium as claimed in claim 9, wherein the display orientation of the 3D image is adjusted by rotating the 3D image in a rotation mode corresponding to the motion direction and the motion angle.

11. The storage medium as claimed in claim 9, wherein the display orientation of the 3D image is adjusted by searching for a 3D image model stored in a storage system of the electronic device according to the motion direction and the motion angle.

12. The storage medium as claimed in claim 9, wherein the touch screen is touched by a user using a stylus or a finger to slide across the touch screen.
